(19) United States
(12) Patent Application Publication
(10) Pub. No.: US 2006/0188122 A1
(43) Pub. Date: Aug. 24, 2006

(54) Swivel elbow

(76) Inventor: Richard C. Smith, Costa Mesa, CA (US)

Correspondence Address: MACPHERSON KWOK CHEN & HEID LLP, 1762 TECHNOLOGY DRIVE, SUITE 226, SAN JOSE, CA, 95110, US

(21) Appl. No.: 11/403,646

(22) Filed: Apr. 13, 2006

Related U.S. Application Data
(63) Continuation-in-part of application No. 10/769,158, filed on Jan. 29, 2004.
(63) Continuation-in-part of application No. 11/247,105, filed on Oct. 11, 2005.

(51) Int. Cl. H04R 25/00

(52) U.S. Cl. 381/382; 381/370

(57) ABSTRACT

A system and method are disclosed for attaching acoustic tubing to an earpiece. An elbow can be configured to rotate such that the acoustic tubing can more readily be routed as desired, such as behind the ear. The elbow can have a first tube that attaches to the earpiece and a second tube that attaches to the acoustic tubing. The second tube can be rotatably attached to the first tube, such as via a collar of the second tube that rides within a groove of the first tube.

### RELATED APPLICATIONS

This patent application is a continuation-in-part (CIP) patent application of U.S. patent application Ser. No. 10/769,158, filed on Jan. 29, 2004 and entitled Ambidextrous Earpiece (docket no. M-15596 US), and is a continuation-in-part (CIP) patent application of U.S. patent application Ser. No. 11/247,105, filed on Oct. 11, 2005 and entitled Earpiece With Flanged Extension (docket no. M-15744 US), the entire contents of both of which are hereby expressly incorporated by reference.

### TECHNICAL FIELD

The present invention relates generally to acoustics. The present invention relates more particularly to an elbow for use with an earpiece, such as those earpieces commonly used with the two way radios of police officers and military personnel.

### BACKGROUND

Elbows for use with earpieces are well known. Such elbows are used with police and military two-way radios to attach acoustic tubing to the earpiece. The elbow provides acoustic communication from the acoustic tubing to the earpiece via a bore formed contiguously through the acoustic tubing, elbow, and the earpiece.

The elbow forms a right angle turn so that the acoustic tubing can extend along the wearer's head, instead of away therefrom. Without the elbow, the acoustic tubing would extend generally perpendicularly away from a wearer's head. This may be awkward and could result in the acoustic tubing inadvertently getting caught on something and the earpiece thus being undesirably pulled out of the wearer's ear.

Contemporary elbows have proven generally useful for their intended purpose. However, they possess deficiencies that which detract from their overall utility and desirability

For example, an elbow should be oriented such that it causes the acoustic tubing to extend away from the ear in a desired direction. Generally, it is desirable for the acoustic tubing to extend away from the earpiece in a manner such that it can readily be routed behind the ear and along the user's head as mentioned above. Thus, a wearer must take care to assure that a contemporary elbow is oriented correctly. Otherwise, a contemporary elbow will improperly route the acoustic tubing.

Taking care to orient an elbow is an added task. It is one more thing that police officers and military personnel must do when preparing for duty. As those skilled in the art will appreciated, sometimes it is necessary for police and military personnel to prepare for duty as quickly as possible. In such instances, it is important to minimize the amount of time that is required for such preparation. Eliminating the need to orient the elbow would help to minimize the time required for preparation for duty. Thus, it is desirable to provide an elbow that does not require that the user orient it in any particular way.

### BRIEF SUMMARY

A system and method for facilitating the attachment of acoustic tubing to an earpiece is disclosed. A swivel elbow can comprise a first tube having a first bore and a second tube having a second bore. The first bore can be in acoustic communication with the second bore. One or more openings can be formed in the first tube, so as to facilitate acoustic communication between the first and second tubes.

The second tube can be rotatably attached to the first tube. Thus, the acoustic tubing can be easily moved with respect to the earpiece, without having to manually repositioned the elbow. That is, as the earpiece is positioned within the conchae bowl of an ear, the second tube will rotate to the desired position thereof such that there is no need to manual orient the elbow.

This can be particularly advantageous when the swivel elbow of the present invention is used in combination with an ambidextrous earpiece. An ambidextrous earpiece is an earpiece that is not specifically configured for use in one ear (the right ear or the left ear), but rather can be used in either ear. Use of the swivel elbow permits the ambidextrous earpiece to be placed in the desired ear without manual positioning of the elbow.

Further, use of the swivel elbow permits the ambidextrous earpiece to be removed from one ear and placed into the other ear without manual repositioning of the elbow. This may be advantageous, for example, when repositioning other gear that is worn upon the body. When the earpiece is placed into the ear, the elbow automatically swivels so as to facilitate desired positioning of the acoustic tubing. That is, the elbow rotates so as to position the acoustic tubing along side of the wearer's head, as desired. Thus, the user need not be concerned with the position of the swivel elbow. Such automatic swiveling of the elbow reduces the time required for police and military personnel to prepare for duty.

The first tube can be configured for attachment to an earpiece. The second tube can be configured for attachment to acoustic tubing. Attachment of the first tube to the earpiece and attachment of the second tube to the acoustic tubing can be done in any desired manner. The first tube can be attached to the earpiece in a manner different from the way the second tube is attached to the acoustic tubing. The swivel elbow facilitates acoustic communication from the acoustic tubing, through the earpiece, and to a user's eardrum.

The first tube can have a groove formed therein and the second tube can have a formed collar thereon. The collar can ride within the groove to facilitate rotation of the second tube with respect to the first tube. The groove can be defined by a stop and a head. The groove can alternatively be formed in any other manner.

The head can optionally have a bevel formed thereon to facilitate attachment of the second tube to the first tube. That is, a bevel can be formed such that the collar readily snaps over the head. Alternatively, the second tube can be rotatably attached to the first tube in any other desired manner.

Those skilled in the art will appreciate that rotation of the second tube with respect to the first tube can be accomplished in various ways. For example, a joint between the first tube and the second tube could be formed of a flexible material that facilitates such rotation. As such, discussion herein of the swivel elbow comprising a groove and a collar are by way of example only, and not by way of limitation.

A communication system can be defined by an earpiece such as an ambidextrous earpiece, an optional extension attached to the earpiece such as a flanged extension, a swivel elbow attached to the earpiece, acoustic tubing attached to the swivel elbow, a speaker attached to the acoustic tubing, electric cable attached to the speaker, and a two-way radio attached to the cable. The communication system can comprise a device other than a two-way radio. For example, the communication can comprise a cellular telephone, a one-way radio, an audio player such as an MP3 player, or any other desired audio device.

The swivel elbow of the present invention allows an earpiece, such as an ambidextrous earpiece, to be placed in a user's ear more quickly. As discussed above, the ability to place an earpiece in the ear more quickly can be an important advantage in police and military applications. This invention will be more fully understood in conjunction with the following detailed description taken together with the following drawings.

### BRIEF DESCRIPTION OF THE DRAWINGS

FIG. 1 is a semi-schematic view of a swivel elbow of an exemplary embodiment of the present invention;

FIG. 2 is a semi-schematic view of the first tube of the swivel elbow of FIG. 1;

FIG. 3 is a semi-schematic view of the second tube of the swivel elbow of FIG. 1;

FIG. 4 is a is a cross-sectional view of the first tube of FIG. 2;

FIG. 5 is a cross-sectional view of the second tube of FIG. 3;

FIG. 6 is a semi-schematic view of an exemplary earpiece with extension having a swivel elbow according to an embodiment of the present invention;

FIG. 7 is a semi-schematic view of an earpiece (such as that of FIG. 6) inserted into an ear, wherein acoustic tubing is attached to the earpiece via the swivel elbow of FIG. 1; and

FIG. 8 is a semi-schematic view of a communication system using the swivel elbow according to one embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION OF THE INVENTION

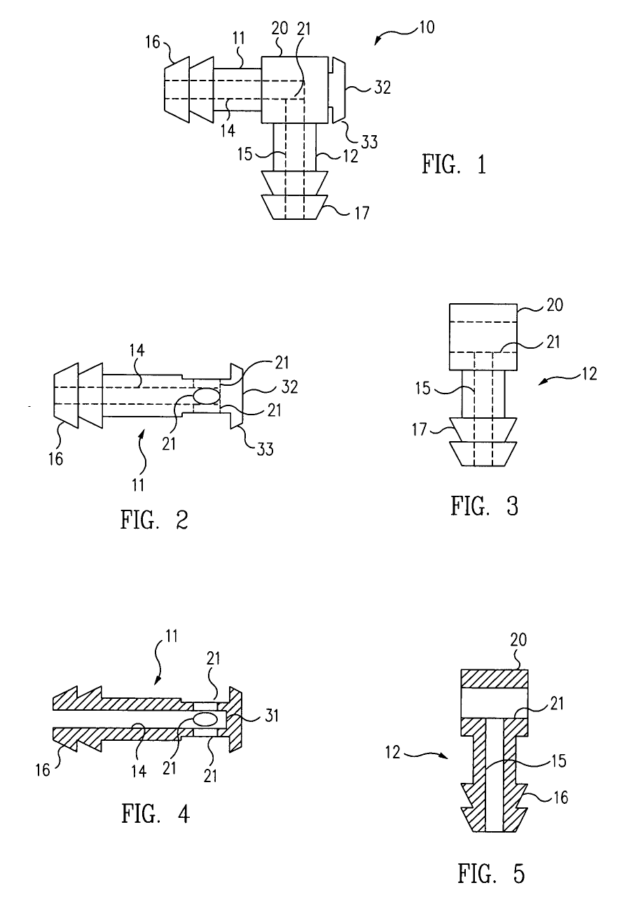

Referring now to FIGS. 1-5, a swivel elbow 10 can comprise a first tube 11 and a second tube 12 that are attached to one another such that second tube 12 can rotate with respect to first tube 11. That is, second tube 12 can swivel about to first tube 11. First tube 11 can comprise an elongated tubular member having a bore 14 formed generally therethrough. Similarly, the second tube 12 can comprise an elongated tubular member having a bore 15 formed generally therethrough. Both the first tube 11 and the second tube 12 can be formed of a substantially rigid polymer material.

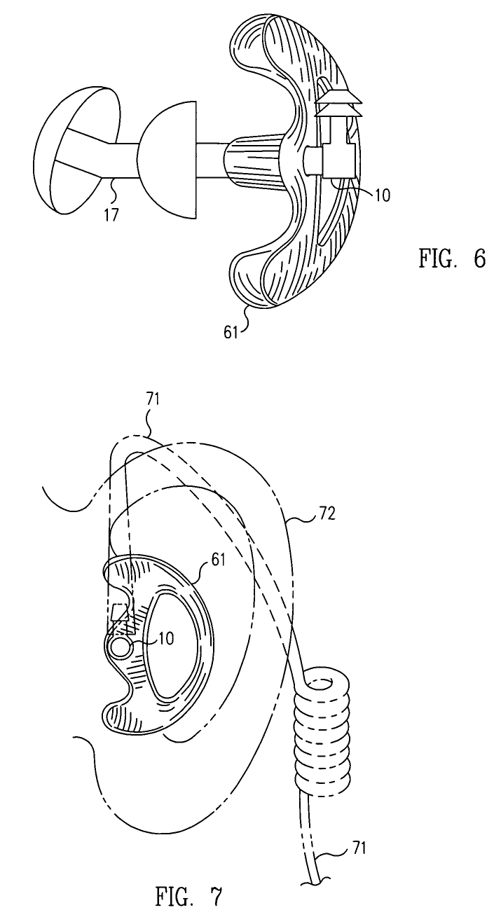

First tube 11 can be configured to attach to an earpiece (as shown in FIG. 6, for example). Second tube 12 can be similarly configured to attach to acoustic tubing (as shown in FIG. 7). For example, barbs 16 formed upon first tube 11 can be used to attach first tube 11 to the earpiece. Likewise, barbs 17 formed upon second tube 12 can be used to attach second tube 12 to the acoustic tubing.

Bore 14 of first tube 11 can be generally contiguous with the bore 15 of second tube 12 such that sound is readily communicated from the acoustic tubing through second tube 12 and first tube 11 to the earpiece. One or more openings 21 can be formed at the proximal end of first tube 11, so as to facilitate the communication of sound from second tube 12 to first tube 11. Optionally, a filter, such as a Hochs filter can be disposed within or attached to either first tube 11 or second tube 12, so as to facilitate desired filtering of sound communicated therethrough.

Alternatively, a filter such as a Hochs filter can be built into or formed integrally with first tube 11 and/or second tube 12. That is, the structures of the filter can be molded into first bore 15 and/or second bore 15. In this manner, the filter is formed along with the first tube 11 and/or second tube 12 and the cost associated with purchasing and installing a separate filter is desirably mitigated.

A collar 20 can be formed upon the proximal end of the second tube 12 to facilitate attachment of the second tube 12 to the first tube 11. Collar 20 defines a bore 21 that receives that portion of first tube 11 having groove 25 formed thereon. Collar 20 can ride within a groove 25 that is defined by stop 26 and head 32 of the first tube 11. In this manner, second tube 12 can rotate about first tube 11. Stop 26 and head 32 define a pair of detents that cooperate so as to maintain desired positioning of second tube 12 with respect to first tube 11.

Head 32 of first tube 11 can have a bevel 33 form thereon, so as to facilitate attachment of second tube 12 to first 11 tube by sliding collar 20 over head 32 and into groove 25. Head 32 can have an outer diameter that is slightly larger than the inner diameter of collar 20. Head 32 and/or collar 20 may deform somewhat as collar 20 is forced over head 32. That is, the collar 20 can be snapped over the proximal end of first tube 11. In this manner, easy assembly of swivel elbow 10 is facilitated.

Referring now to FIG. 6, swivel elbow 10 is shown attached to an earpiece 61. Earpiece 61 is optionally attached to a flanged to extension 17. A contiguous bore is formed through swivel elbowed 10, earpiece 61, and flanged extension 17. Thus, sound can readily be communicated therethrough.

Earpiece 61 can optionally be an ambidextrous earpiece. An ambidextrous earpiece can be an earpiece that is generally symmetrical (such as that shown in FIG. 6), so that it can be used in either ear. That is, by merely flipping the earpiece over (such as about its horizontal centerline), the earpiece can used in the opposite ear. One example of such an ambidextrous earpiece is disclosed in United States patent publication no. 20050008180, published Jan. 13, 2005 and entitled Ambidextrous Earpiece, the entire contents of which are incorporated herein by reference.

Referring now to FIG. 7, earpiece 61 is shown disposed within the conchae of an ear 72. Flanged extension 17 is disposed within the ear canal. Swivel elbow 10 can be advantageously used to facilitating desired positioning of acoustic tubing 71. That is, swivel elbow 10 can move or swivel such that acoustic tubing 71 can readily be routed behind a wearer's ear 72, as shown.

The use of swivel elbow 10 is particularly advantageous when used with an ambidextrous earpiece. When swivel elbow 10 is used with an ambidextrous earpiece, it readily facilitates insertion of the earpiece, as well as movement of the earpiece from one ear to a another ear, without requiring that the elbow be manually oriented so as to desirably route the acoustic tubing behind the ear as shown in FIG. 7. A user can merely insert an earpiece or remove an earpiece from one ear and reinsert that earpiece into the other ear without concern as to the position of the elbow.

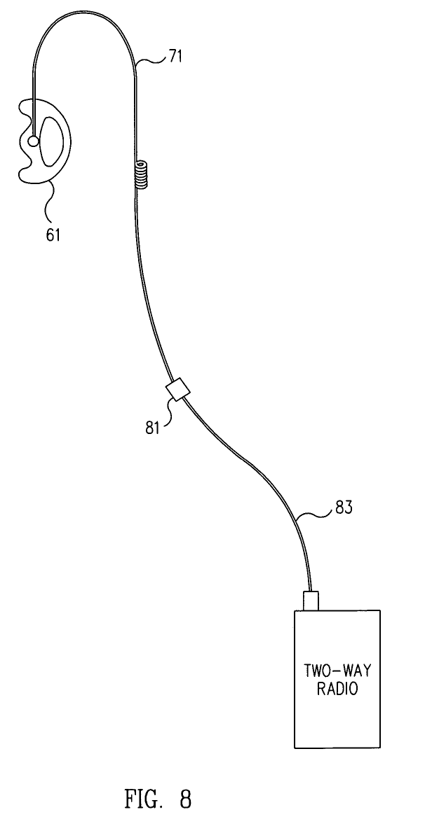

Referring now to FIG. 8, a communication system can comprise an earpiece 61 attached to acoustic tubing 71, via swivel elbow 10. A speaker 81 is attached to acoustic tubing 71. The speaker is electrically attached to a two-way radio 82 via cable 83.

The swivel elbow of the present invention advantageously mitigates the time and effort required for police, military, and other personnel to prepare for duty. This includes both the time needed to initially prepare for duty, such as when suiting up, as well as the time needed to make adjustment to gear, such as when re-arranging items of gear upon a person. Thus, the present invention can enhance response times. As those skilled in the art will appreciated, enhanced response times are very desirable and can substantially influence the outcome of a response.

Further, swiveling of the elbow of the present invention tends to maintain the earpiece and acoustic tubing in desire positions by accommodating variations in the position of a wearer's gear as well as movement of the wearer and the wearer's gear. For example, if a wearer's hat or helmet causes the acoustic tubing to move or be re-positioned, then the swivel elbow of the present invention can rotate so as to accommodate such movement without substantially increasing stress upon the earpiece that might cause the earpiece to be undesirably pulled from the wearer's ear.

By accommodating such movement of the acoustic tubing, the swivel elbow of the present invention enhances comfort associated with use of the earpiece. Because of this, the earpiece can be worn for longer periods of time and with less need for manual adjustment or re-positioning due to discomfort. Moreover, enhanced comfort makes the earpiece less of a distraction and thus better allows a wearer to perform necessary duties without loss of focus.

Although the swivel elbow of the present invention is discussed herein as being used to connect acoustic tubing to an earpiece, other applications of the swivel elbow can be used to communicate various fluids, as well as in other acoustic applications.

Embodiments described above illustrate, but do not limit, the invention. It should also be understood that numerous modifications and variations are possible in accordance with the principles of the present invention. Accordingly, the scope of the invention is defined only by the following claims.

1. A swivel elbow.

2. An elbow comprising:
a first tube having a first bore;
a second tube having a second bore; and
wherein the second tube is rotatably attached to the first tube and the second bore is in acoustic communication with the first bore.

3. The elbow as recited in claim 2, wherein the first tube and second tube are configured for use with an earpiece.

4. The elbow as recited in claim 2, wherein the first tube is configured to attach to an earpiece and the second tube is configured to attach to acoustic tubing.

5. The elbow as recited in claim 2, wherein the first bore is configured to be in acoustic communication with a bore of an earpiece and/or flange and the second bore is configured to be in acoustic communication with acoustic tubing.

6. The elbow as recited in claim 2, wherein the second tube comprises opening formed therein, the opening being configured to rotatably receive a portion of the first tube.

7. The elbow as recited in claim 2, wherein the second tube comprises an opening formed generally orthogonal with respect to the second bore and the first tube comprises a portion thereof that is rotatably received within the opening, the portion of the first tube having at least one opening formed therein to facilitate acoustic communication between the first and second bores.

8. The elbow as recited in claim 2, wherein the second tube is attached to the first tube via at least one detent.

9. An elbow for rotatably and acoustically coupling acoustic tubing to an earpiece/flange assembly, the elbow comprising:
a first tube having a first bore, the first tube being configured to attach to the earpiece/flange assembly;
at least one detent formed upon the first tube;
a second tube having a second bore, the second tube being rotatably attached to the first tube and being configured to attach to the acoustic tubing, the second tube comprising an opening formed therein such that the opening is configured to receive a portion of the first tube such that the detent(s) attach the second tube to the first tube.

10. An earpiece assembly comprising:
an earpiece;
an extension attached to the earpiece;
an elbow attached to the earpiece or the extension, the elbow comprising:
a first tube having a first bore;
a second tube having a second bore; and
wherein the second tube is rotatably attached to the first tube such that the second bore is in acoustic communication with the first bore.

11. An earpiece assembly as recited in claim 10, wherein the earpiece is an ambidextrous earpiece.

12. A communication link comprising:
an earpiece;
an extension attached to the earpiece;
an elbow attached to the earpiece or the extension, the elbow comprising:
a first tube having a first bore;
a second tube having a second bore; and
wherein the second tube is rotatably attached to the first tube and the second bore is in acoustic communication with the first bore;
acoustic tubing in acoustic communication with the elbow;
a speaker in acoustic communication with the acoustic tubing,
an electrical cable in electrical communication with the speaker; and
a connector in electrical communication with the electrical cable.

13. A communication system comprising:
an earpiece;
an extension attached to the earpiece;
an elbow attached to the earpiece or the extension, the elbow comprising:
a first tube having a first bore;
a second tube having a second bore; and
wherein the second tube is rotatably attached to the first tube and the second bore is in acoustic communication with the first bore;
acoustic tubing in acoustic communication with the elbow;
a speaker in acoustic communication with the acoustic tubing,
an electrical cable in electrical communication with the speaker;
a connector in electrical communication with the electrical cable; and
a radio to which the connector can connect.

14. A method for making an elbow, the method comprising attaching a second tube to a first tube such that the second tube can rotate with respect to the first tube and such that the second tube is in acoustic communication with the first tube.

15. The method as recited in claim 13, wherein attaching the second tube to the first tube comprises snapping the second tube over a portion of the first tube such that the second tube is attached to the first tube by a detent.

16. A method for using an ambidextrous earpiece, the method comprising:
placing the ambidextrous earpiece into an ear; and
rotating a second tube of an elbow about a first tube thereof.
